(19) United States
(12) Patent Application Publication
(10) Pub. No.: US 2025/0322152 A1
(43) Pub. Date: Oct. 16, 2025

(54) System and Method for Utilizing a Large Language Model (LLM) for Labeling Data-Items for Training a Machine Learning (ML) Model

(71) Applicant: VARONIS SYSTEMS, INC., New York, NY (US)

(72) Inventors: Amit Osi, Tel Aviv (IL); Ron Sneh, Atlit (IL)

(21) Appl. No.: 18/636,297

(22) Filed: Apr. 16, 2024

(51) Int. Cl. G06F 40/20

(52) U.S. Cl. CPC G06F 40/20

(57) ABSTRACT

A Large Language Model (LLM) is configured to automatically label non-labeled textual data-items for the purpose of creating a training dataset for training a Machine Learning (ML) model. The ML model is thus trained on LLM-labeled textual data-items; and the ML model can be deployed to classify new or incoming documents or messages or other textual data-items. Additionally, a Vision and Language Model (VLM) or a Large Multimodal Model (LMM) or a large multiple-modalities model (LMM) can process data from two or more modalities (visual data, textual data), and is configured to automatically label non-labeled images for the purpose of creating a training dataset for training a Deep Neural Network (DNN) or a Deep Convolutional Neural Network (Deep CNN) model. The DNN model is thus trained on VLM-labeled images; and the DNN model can be deployed to classify new or incoming images.

### FIELD

Some embodiments are related to the field of computerized systems.

### BACKGROUND

A large corporation, organization, or other entity may have thousands of team-members who utilize computing devices for various purposes; for example, to send and receive electronic mail, to engage in video calls, to browse the Internet, to compose documents, to access data repositories, to prepare presentations, to manage projects, or the like.

Team-members of a large organization may cumulatively produce, edit, send and/or receive thousands of documents or messages per day or even per hour.

### SUMMARY

Some embodiments include systems and methods for utilizing a Large Language Model (LLM) for automatically labeling non-labeled textual data-items for the purpose of creating a training dataset for training a Machine Learning (ML) model. The ML model is thus trained on LLM-labeled textual data-items; and the ML model can be deployed to classify new/incoming documents or messages or other data-items.

Some embodiments include systems and methods for utilizing a Vision and Language Model (VLM) or a Language and Vision Model (LVM) or a similar Large Multimodal Model (LMM) or a large multiple-modalities model that can process data from two or more modalities (e.g., visual, textual, images, video frames, videos, audio, spreadsheets, tabular data) for automatically labeling non-labeled images for the purpose of creating a training dataset for training a Deep Neural Network (DNN) or a Deep Convolutional Neural Network (Deep CNN) model. The DNN model is thus trained on VLM-labeled images; and the DNN model can be deployed to classify new/incoming images.

Some embodiments may provide other and/or additional benefits and/or advantages.

### BRIEF DESCRIPTION OF THE DRAWINGS

FIG. 1 is a flow-chart of a computerized method, in accordance with some embodiments.

FIG. 2 is a chart demonstrating a plotted curve of a Receiver Operating Characteristic (ROC), in accordance with some demonstrative embodiments.

FIG. 3 is a flow-chart of a computerized method in accordance with some embodiments.

FIG. 4 is a schematic block diagram illustration of a system for automatically constructing an ML-based classifier for textual items, in accordance with some demonstrative embodiments.

FIG. 5 is a schematic block diagram illustration of a system for automatically constructing an ML-based classifier for images (or video frames, or videos), in accordance with some demonstrative embodiments.

### DETAILED DESCRIPTION OF SOME DEMONSTRATIVE EMBODIMENTS

Some embodiments provide systems and methods for automatically and efficiently generating or creating a Machine Learning (ML) classification model for unlabeled data; and particularly, for automatically creating a ML model for classifying text, or automatically creating a ML model for classifying images or videos or other visual content. Some embodiments may operate to automatically generate or create a dataset of machine-labeled items (e.g., textual items and/or images, videos), which is then utilized to automatically construct and/or train and/or update a ML model for classification of unlabeled data-items or unclassified data-items or not-yet-labeled data-items.

Embodiments of the present invention may be used in conjunction with a variety of use cases. In a first demonstrative and non-limiting use case, some embodiments may be used in conjunction with constructing a system for automatically estimating the real Urgency Level of an incoming message (e.g., an incoming email message; an incoming text/SMS/IM message; an incoming letter that arrived by fax or by mail or by courier and was converted into a digital form by scanning and optionally with Optical Character Recognition (OCR) or by being typed into a computer). For example, the Applicant has realized that in the context of cyber security and particularly security of email-related or email-connected systems, one of the Key Risk Indicators (KRIs) is urgency level, or the “call to action”, or the alleged level of urgency that an incoming message attempts to convey and its relation to an “actual” or estimated level of urgency. For example, realized the Applicant, an email message that conveys to the recipient that an immediate damage would happen unless the recipient immediately acts, is often more likely to be fraud-related, compared to an email message that merely reports to the recipient about a non-urgent matter. Accordingly, realized the Applicant, it may be beneficial to automatically generate this KRI of “urgency level” or “urgency score” for an incoming email message (or other incoming message), as an assistive tool in evaluating the risk associated with that message. However, realized the Applicant, estimating the urgency level of an incoming email message is not an easy task. Indeed, a Large Language Model (LLM) can be used to analyze each and every incoming message, but this approach is often not cost-effective or time-effective; as a large organization may receive millions of email messages per day. Rather, some embodiments of the present invention are configured to firstly take and use a sample of email messages, and to command the LLM to classify the urgency level of each email message of that sample dataset (e.g., by commanding the LLM with a prompt such as, “Please generate an Urgency Score for the following incoming email message, in a scale of 0 to 100; where 0 indicates an entirely non-urgent message, for which no damage would happen and no adverse results would happen if the message is not read and/or not responded and/or not acted upon; and where 100 indicates an extremely urgent message, in which significant and irreparable damage is expected to happen if the message is not immediately read and/or not responded and/or not acted upon”). Then, the system automatically constructs and trains a Machine Learning (ML) model, with the text of the email messages as input and with the Urgency Score as output; and then, the ML model that was trained on a sample dataset of LLM-analyzed email messages, can be run and applied to new incoming emails, and can efficiently generate an ML-based (and not an LLM-based) Urgency Score for every incoming email message as it arrives to the organization and/or to the recipient, in real time or in near real time.

In a second demonstrative and non-limiting use case, some embodiments may be used in conjunction with constructing a system for automatically detecting (or estimating) that a document (or data-item) includes sensitive/confidential information. For example, realized the Applicant, in the context of data protection and confidentiality, an important or useful task is the detection of sensitive information within organizational documents. However, realized the Applicant, this task, may often be challenging, labor-intensive, effort-consuming, and/or error-prone; particularly in a large organization that handles or generates thousands of documents per day or per hour. In accordance with some embodiments, the system initially takes a representative sample of organizational documents, and commands the LLM to analyze each document and to determine whether or not the document contains sensitive/confidential information; by generating a binary flag (“yes, contains sensitive information” or “no, does not contains sensitive information), or by generating a Sensitivity Score (e.g., where 0 indicates that the data in the document is entirely non-sensitive and non-confidential, and where 100 indicates that the data in the document is extremely sensitive and extremely confidential). Then, a ML model or an Auto-ML may be automatically trained on the LLM-labeled dataset, and the ML model can then be implemented or utilized across a variety of repositories or sub-systems of the organization; for example, to perform ML-based estimation (and not LLM-based estimation) of the sensitivity level of each document that is generated/sent/received/stored/modified/deleted.

Some embodiments of the present invention may thus address the challenges that are associated with the high cost and labor-intensive process of manually labeling dataset(s) of extensive textual items in order to construct or to train a Machine Learning (ML) model and a ML-based application. Some embodiments may be particularly beneficial for organizations that need to employ scalable text classification solutions on a large scale.

The significant cost-effectiveness of the systems and methods of embodiments of the present invention is clear particularly when applied to large datasets. For example, a demonstrative scenario includes 100,000 data points. If the system operates such that each data point costs $0.1 to process, the total expense associated with processing the 100,000 data-points would amount to $10,000; and this is a substantial cost for virtually any business, particularly if numerous decisions of this type are needed to be performed per day or per hour. In contrast, the utilization of a trained ML model represents a much more economical and efficient approach. Such a ML model can run on a Central Processing Unit (CPU), without the need to use expensive Graphics Processing Unit (GPU) resources. This can reduce the cost to be near-zero, offering a clear contrast to the significant expense associated with manual data-point processing. Hence, in terms of cost-effectiveness and resource allocation, realized the Applicant, the utilization of a trained ML model offers an attractive alternative, particularly when dealing with large-scale datasets. It is noted that the difference and the advantage is not only in costs; but rather, in variety of other aspects as well. For example, a system with a single CPU (or with several CPU) may be constructed and configured in accordance with some embodiments, to perform ML-based analysis of a large volume of data-points or data-items (and particularly, a large number of documents or messages or text-segments), in a fast and efficient manner; obviating the need to construct and maintain a server farm of GPUs to perform slow and expensive LLM-based analysis of each document/message.

Some embodiments of the present invention thus use a Large Language Model (LLM), or a plurality or chain or set of such LLMs, to automatically label textual data. The system then uses a cost-effective ML model, such as CatBoost, that is trained on that LLM-labeled data. This significantly minimizes both the cost and effort required for dataset preparation and deployment for text classification tasks.

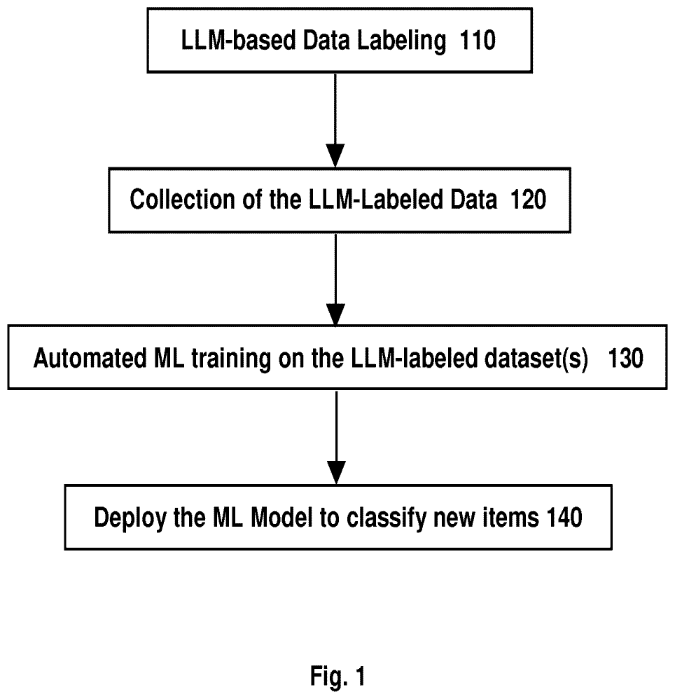

Reference is made to FIG. 1, which is a flow-chart of a computerized method in accordance with some embodiments.

As indicating in Block 110, LLM-based Data Tagging (or, LLM-based classification, or LLM-based labeling) is performed. Given a set of documents, the system takes a sample of K documents (for example, K being 2,000 or 8,000); and a LLM (such as OpenAI ChatGPT 4, or Microsoft Copilot, or Google Gemini, or Claude 3, or Mistral, or Meta Llama2, or the like) reviews each document and labels (or tags, or classifies) it according to a particular classification task that is defined in the prompt that is fed into the LLM. For example, a set of 2,000 email messages may be fed (separately, in series) to the LLM, with a prompt that commands the LLM to generate an Urgency Score for each message, or to generate a Sensitivity Score for each message (or document), or other prompt that is pre-defined and is tailored for the particular classification task. It is noted that the same prompt can be fed to the LLM for each such textual item; and there is no need to construct or to prompt-engineer a different prompt for evaluating each textual item.

As indicated in Block 120, Data Collection is performed: the labeled data is collected, and is divided into a Training Set and a Testing Set.

As indicated in Block 130, Auto-ML Training is performed: the collected data is used to train an automated ML model, which then outputs a predictive ML model.

As indicated in Block 140, the ML Model is then Deployed, as an application or a system or a device that employs the trained ML model to make predictions (or classifications) on the full dataset, or on newly-created/newly-incoming documents or messages or items. The ML model can also be used in real-time production environments for immediate text classification in real time or in near real time.

In a demonstrative embodiment, a text classification ML model is automatically constructed from scratch using data items that were originally non-labeled/non-tagged/non-classified. For a given corpus of text items (e.g., documents, messages), the system automatically applies a LLM to label each textual item, with a prompt that is defined in advance as suitable for a particular text classification task (e.g., urgency score; sensitivity score). Optionally, if there is no given corpus of textual items, a synthetic dataset of textual items can firstly be created using an LLM, and can then be labeled using the same LLM or using a different LLM. The output of the LLM-based labeling stage is a dataset of textual items, and the corresponding LLM-generated label (or tag, or classification) for each of those textual items. Then, a ML model (e.g., CatBoost) is trained with this data, and the trained ML model is then deployed as an application in a production environment. The system thus constructs a low-cost ML model, that leverages initial LLM-based labeling of an initial dataset that is then utilized for training the ML model. The cost and resources that are required for training and deploying the ML model are generally negligible, particularly in comparison with performing a full LLM-based analysis of each document, and particularly when applied on a large scale that has to process thousands or even millions of documents/messages per day.

In a demonstrative implementation, a system was automatically constructed to perform automated analysis of the Urgency Level of incoming messages, by generating an Urgency Score for each such incoming message. Firstly, LLM analysis was performed using a suitable prompt, to generate an Urgency label (e.g., “urgent message” or “non-urgent message) for each message in a sample dataset of incoming email messages. For example, OpenAI GPT 3.5 Turbo can be used for reduced costs, or OpenAI GPT 4 can be used for high-quality results. Then, a stage of Dataset Observations was conducted, based on a dataset of email messages that are known to be “phishing”/fraudulent messages. It was observed that: (a) Email messages having an Urgent label are 88% likely to be “phishing”/fraudulent messages; whereas, (b) Email messages having a Non-Urgent label (or, email messages that were not labeled as Urgent) are only 44% likely to be “phishing” fraudulent messages, indicating that the urgency label is a probable good indicator for phishing alerts.

In the next stage, ML Model Training was performed, by training a CatBoost ML model using bag of words and Term Frequency-Inverse Document Frequency (TF-IDF) embedding from the body content and subject line of each email message.

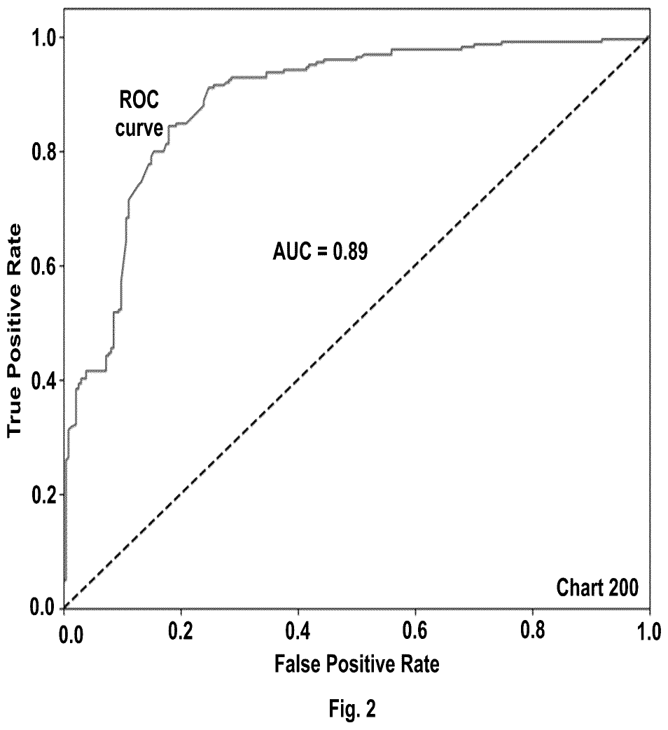

Evaluating the ML Model Performance, a Receiver Operating Characteristic (ROC) curve was generated to plot the True Positive Rate (TPR) against the False Positive Rate (FPR). The area under the ROC curve (AUC) in this demonstrative implementation was 0.89, suggesting that this ML model is quite effective, and indicating there may still be room for improvement (for example, by utilizing a more-accurate/high-quality LLM for the initial labeling; or for using two or three LLMs in parallel for initial labeling and then selecting the majority vote or the consensus label). Accordingly, this ML model is deemed to be suitable for production deployment as a cost-saving and resources-effective alternative to message-by-message labeling with a LLM. Reference is made to FIG. 2, which is a chart 200 demonstrating the ROC plotted in this implementation, in accordance with some demonstrative embodiments.

Accordingly, an automated method may include: Collecting non-labeled textual data-items; automatically labeling each of those data-items using an LLM (or using a plurality of LLMs, with a prevailing/consensus/majority vote mechanism in case they reach different labeling results); automatically training an ML model on the LLM-labeled dataset; and then, deploying the ML model to label/classify new textual items.

It is noted that in accordance with some embodiments, the LLM does not generate a dataset of “synthetic” data-items; but rather, the LLM uses an already-existing, non-synthetic, “real” data-items (e.g., email messages; documents), non-AI-generated textual data-items, to generate an enriched dataset that has the LLM-generated labels, and that enriched dataset is then used to efficiently train a ML model for classification of further textual items. In some embodiments, optionally, the LLM may even be fine-tuned so that it will generate the labeled data with perfect fit for ML training (e.g., schema, scores). Optionally, augmentation techniques may further be used to improve the LLM performance.

In some embodiments, optionally, if the original non-labeled dataset is too small, or is non-existing, then a LLM can be used to initially to generate synthetic data, and then the same LLM or another LLM may be used to label that data. It is noted that this approach is still distinct from mere generation of synthetic and pre-labeled data.

Some embodiments may innovatively utilize a similar approach in order to efficiently construct and deploy an image classification model (or similarly, a video classification model), given an initial dataset of non-labeled images. For example, an automated system may be configured to leverage a Language and Vision Model (LVM) or Vision and Language Model (VLM) or other Large Multimodal Model (LMM), such as GPT Vision or LLaVa or BakLlaVa or Qwen-VL or CogVLM, capable of processing textual data and visual data, and capable of “seeing” or recognizing images and understanding/recognizing content of images, to automatically label/annotate/classify/tag a dataset of non-labeled images to make them suitable for utilization as a labeled dataset of images for automatically training thereon a ML model for image classification. The Language and Vision Model thus creates a dataset of images and their corresponding labels; and the labeled dataset is then used to train a Neural Network (NN) model (as typically a non-NN Machine Learning model would not suffice), which can be constructed from the ground up or by fine-tuning an existing model (such as a Visual Geometry Group (VGG) model, or VGG-16 or VGG-19, or other deep Convolutional NN). It is noted that VGG is only a non-limiting example, and other DNNs or CNNs or Deep-CNNs can be used; for example: ResNet (Residual Networks) from Microsoft Research, having a deep architecture, with versions containing up to 152 layers; and with “skip connections” features that allow gradients to flow through the network more effectively, significantly reducing the problem of vanishing gradients in deep networks; (2) Inception (also known as GoogLeNet), having “inception modules” that perform multiple convolutions at different scales concurrently within the same module, allowing the network to adapt to various scales of features; MobileNet, particularly useful for mobile and embedded vision applications, focusing on reducing the number of parameters and computations; DenseNet (Densely Connected Convolutional Networks), which improves on feature re-use in deep networks, as each layer in DenseNet is connected to every other layer in a feed-forward fashion, making the network more efficient and reducing the problem of vanishing gradients; EfficientNet models, that use a scaling method that uniformly scales all dimensions of depth/width/resolution using a compound coefficient, allowing a systematic and effective way to scale up CNNs and make them more efficient; Xception model, replacing Inception modules with depth-wise separable convolutions, and based on the feature that mapping of cross-channel correlations and spatial correlations in the feature maps of convolutional neural networks can be entirely decoupled

The system thus automatically creates an efficient and cost-effective Computer Vision model, capable of deployment in a production environment with substantially lower costs than utilizing a Language and Vision Model (such as GPT Vision), particularly when implemented on a large scale. Some embodiments may thus utilize the above-described concepts, by integrating the use of a Language and Vision Model and Neural Networks, diversifying the range of Artificial Intelligence (AI) technologies utilized and increasing the model's overall efficiency and cost-effectiveness. The Computer Vision model, that is automatically constructed using a NN or CNN or a Deep NN (DNN) or a Deep CNN that is trained on the VLM-labeled dataset of images, can be deployed for a variety of classification tasks; for example, to classify images as a “spam related” or not, to classify images as “containing objectionable content” or not, to classify images as “containing nudity” or not, or the like. This may allow an organization to efficiently construct and deploy an image-classification application that can efficiently run on a large scale.

In accordance with some embodiments, a Language and Vision Model or a Vision and Language Model (VLM) or other Large Multimodal Model (LMM) is used to automatically label image data. The system then employs a cost-effective, Machine Learning model such as NN or CNN, trained on this VLM-labeled data (images and their VLM-generated labels). This minimizes the cost and the efforts/resources that are required for dataset preparation and deployment for image classification tasks.

In a demonstrative embodiment, the following method can be used. (1) Data Tagging; given a set of non-labeled images, the system takes a sample of K images; the VLM analyzes each image and labels it according to the image classification task that is defined in the prompt (e.g., Please analyze the image and classify it as either “contains nudity” or “does not contain nudity”; or, please analyze the image and classify it as either “likely to be related to fraud/scam” or not). (2) Data Collection: gather the data and divide it into a training set and a testing set. (3) Auto-ML Training, in which the collected data (images, and their VLM-generated labels) is used for training an automated ML model, and particularly a NN or Convolutional NN (CNN) or other Deep NN (DNN) or Deep CNN model, which thus outputs a predictive model. (4) Model Deployment: deploy the trained model to make predictions on the full dataset or on new images, or as part of a real-time production environment for immediate image classification.

Some embodiments may thus automatically and efficiently generate an image classification model, from scratch, using images that are initially non-labeled/non-classified. The initial dataset is labeled automatically by an VLM, using a prompt that is suitable for the particular image classification task that is desired to be constructed. The output is a dataset of images and their corresponding labels. The system then automatically trains a NN/CNN/DNN model (e.g., fully connected) with that dataset, and the resulting is a low-cost ML-based vision model. The cost and the resources required for constructing and deploying the ML-based vision model are negligible compared to those required for running the VLM on each image, especially when the system is structured to scale and to analyze thousands, or even millions, of images per day.

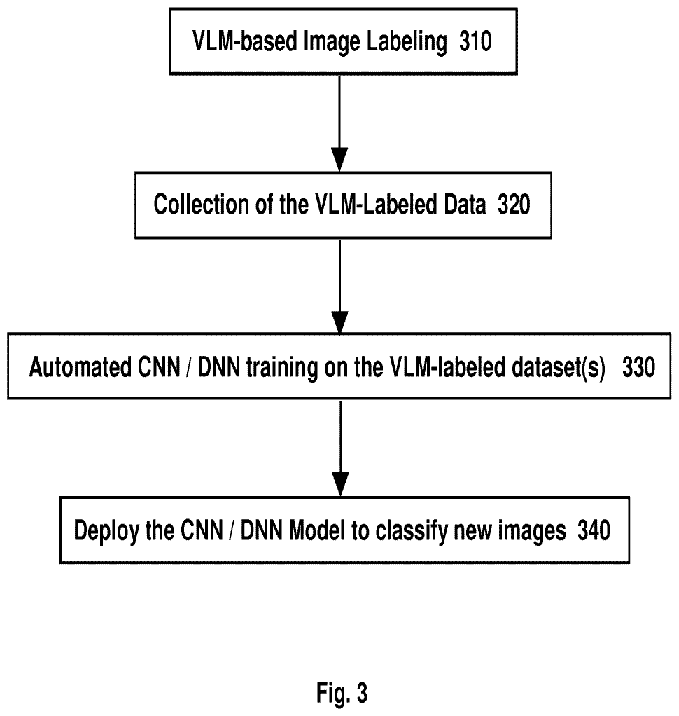

Reference is made to FIG. 3, which is a flow-chart of a computerized method in accordance with some embodiments. For example, a set of non-labeled/non-tagged/non-annotated/non-classified images is labeled using a VLM (block 310), creating a VLM-labeled image dataset (block 320); on which a CNN/DNN is automatically trained (block 330). The resulting CNN/DNN model is then deployed to classify new images (block 340).

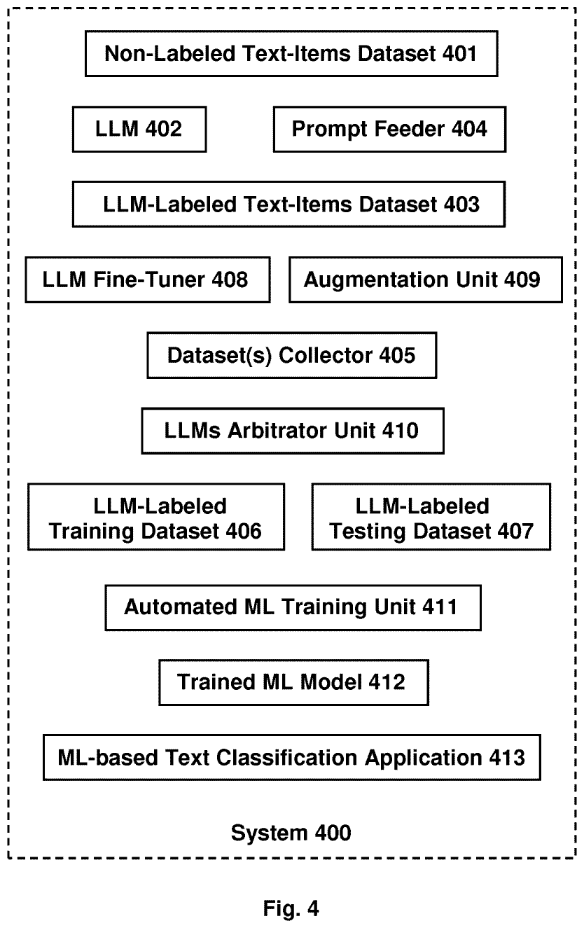

Reference is made to FIG. 4, which is a schematic block diagram illustration of a system 400 for automatically constructing an ML-based classifier for textual items, in accordance with some demonstrative embodiments. System 400 may include, for example: a Non-Labeled Text-items Dataset 401; an LLM 402 to automatically label the text-items of dataset 401, and to generate from them an LLM-Labeled Text-Items Dataset 403. Optionally, a Prompt Feeder Unit 404 feeds the prompt into the LLM for labeling each text-item (e.g., using the same prompt, which is constructed one-time by taking into account the target classification task that the ML model is intended to later perform). A Dataset Collector 405 operates to collect the LLM-based labeling results, and to construct an LLM-Labeled Training Dataset 406 and an LLM-Labeled Testing Dataset 407. Optionally, an LLM Fine-Tuner 408 may be used to fine-tune the LLM (e.g., modify its biases and parameters) in order to improve model fitting. Optionally, an Augmentation Unit 409 may further be used to augment the prompt or the context provided to the LLM for the labeling task. Optionally, instead of using a single LLM 402, a plurality of LLMs may be used; and an LLMs Arbitrator Unit 410 may select the final label if two or more of the plurality of LLMs disagree, based on pre-defined arbitration rules (e.g., an arbitration rule that selects the result of two agreeing LLMs over the result of the third disagreeing LLM). Once the LLM-labeled dataset(s) are established, an Automated ML Training Unit 411 is used to train thereon a ML model, generating a Trained ML Model 412; which can be deployed as part of an ML-based Text Classification Application 413.

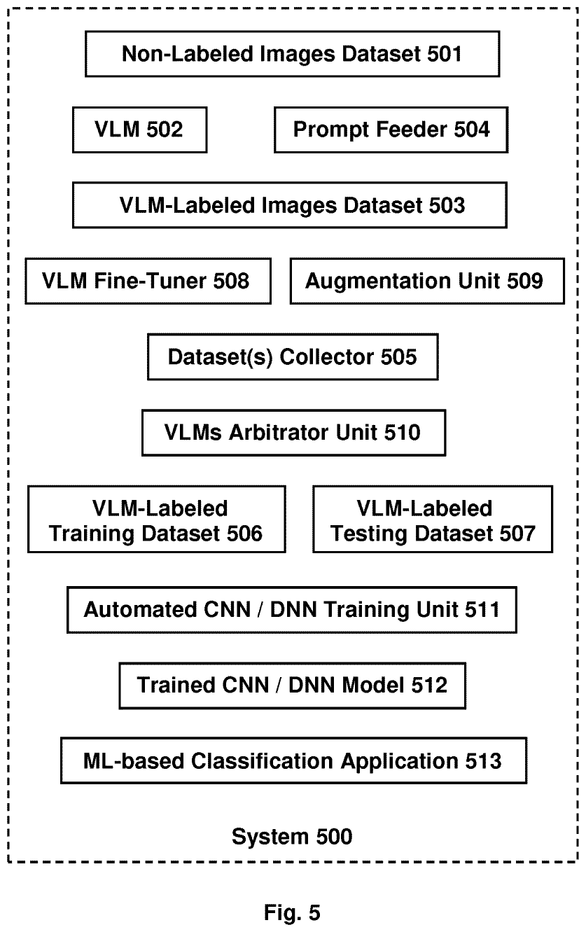

Reference is made to FIG. 5, which is a schematic block diagram illustration of a system 500 for automatically constructing an ML-based classifier for images (or video frames, or videos), in accordance with some demonstrative embodiments. System 500 may include, for example: a Non-Labeled Images Dataset 501; a Language and Vision Model 502 to automatically label the images of dataset 501, and to generate from them a VLM-Labeled Images Dataset 503. Optionally, a Prompt Feeder Unit 504 feeds the prompt into the VLM for labeling each image (e.g., using the same prompt, which is constructed one-time by taking into account the target image classification task that the ML model is intended to later perform). A Dataset Collector 505 operates to collect the VLM-based labeling results, and to construct an VLM-Labeled Training Dataset 506 and an VLM-Labeled Testing Dataset 507. Optionally, an VLM Fine-Tuner 508 may be used to fine-tune the VLM (e.g., modify its biases and parameters) in order to improve model fitting. Optionally, an Augmentation Unit 509 may further be used to augment the prompt or the context provided to the VLM for the image labeling task. Optionally, instead of using a single VLM 502, a plurality of VLMs may be used; and an VLMs Arbitrator Unit 510 may select the final label if two or more of the plurality of VLMs disagree, based on pre-defined arbitration rules (e.g., an arbitration rule that selects the result of two agreeing VLMs over the result of the third disagreeing VLM). Once the VLM-labeled dataset(s) are established, an Automated CNN/DNN Training Unit 511 is used to train thereon a CNN/DNN model, generating a Trained CNN/DNN Model 512; which can be deployed as part of an ML-based Image Classification Application 513.

In some embodiments, system 500 may be similarly configured to enable ML-based classification of video frames, or of video clips/video files/video segments; for example, by extracting a frame, or a representative frame, or a frame-portion, from a video; and by performing the image-classification process with regard to such video frames, and extrapolating the result towards a video segment. For example, if frame number 175 of a video is determined to be related to scams, or to contain nudity, then the entire video segment may be similarly labeled.

Some embodiments provide automated and LMM-based/VLM-based systems for generating machine learning (ML) models for classifying unlabeled data across various domains, including text and visual content such as images or video-frames or videos. Some embodiments leverage large language models (LLMs) for initial data labeling, which then enable the training of cost-effective and efficient ML models. Embodiments of the invention may be used with a variety of applications, ranging from assessing the urgency of incoming messages to detecting sensitive information within documents, and enables automatic constructing of various text/image classification applications. Some embodiments integrate novel methods of automating data labeling and model training, providing advantages in costs, efficiency, and scalability. Some embodiments may be used to solve various challenges of data classification with potential applications across various sectors.

Some embodiments provide a method for classifying unlabeled data items, by performing: Automatically generating a dataset of machine-labeled items by applying a Large Language Model (LLM) to unlabeled textual or visual content to assign preliminary labels; Training a Machine Learning (ML) model on the LLM-labeled dataset; Applying the trained ML model to classify new, unlabeled data items based on the learned classifications.

As an example, some embodiments provide a method for Determining Urgency Levels, or for automatically estimating urgency levels of incoming messages, the method comprising: Sampling a set of incoming messages; Utilizing a Large Language Model (LLM) to generate an Urgency Score for each message in the sample on a predetermined scale; Training a Machine Learning (ML) model on the sampled messages and their corresponding Urgency Scores; Employing the trained ML model to assign Urgency Scores to new incoming messages in real-time or near real-time. Some embodiments may enhance Email Security, or may enhance the security of email communication through urgency classification, by: Sampling incoming email messages within an organization; Generating Urgency Scores for each sampled message using a Large Language Model (LLM); Training a Machine Learning (ML) model on the sampled messages and their Urgency Scores; Deploying the trained ML model to automatically assess and flag incoming email messages based on their Urgency Scores, thereby aiding in the identification of potentially fraudulent or high-risk communications.

As another example, some embodiments provide a method for Detecting Sensitive Information, or for estimating that sensitive or confidential information exists in particular documents, the method comprising: Analyzing a representative sample of organizational documents using a Large Language Model (LLM) to determine the presence of sensitive information; Generating a Sensitivity Score for each document in the sample; Training a Machine Learning (ML) model using the documents and their Sensitivity Scores; Applying the trained ML model to assess the sensitivity of newly created, received, or stored documents across the organization.

Some embodiments provide a method for Automated Image Classification, or a method for constructing a Machine Learning (ML) model for image classification; the method comprising: Labeling a dataset of non-labeled images using a Language and Vision Model (VLM) based on a pre-defined classification prompt/task; Training a Neural Network (NN) model, such as a Convolutional Neural Network (CNN) or a Deep Neural Network (DNN) or a Deep CNN, on the VLM-labeled image dataset; Deploying the trained NN model to classify new images according to the predefined tasks.

Some embodiments provide a method for Real-time Text Classification, or for real-time classification of text-based content, the method comprising: Generating a dataset of LLM-labeled textual items by applying a Large Language Model (LLM) to unlabeled text segments; Training a cost-effective Machine Learning (ML) model on the LLM-labeled dataset; Deploying the trained ML model in a production environment to classify text segments in real-time or near real-time.

Some embodiments provide methods for Reducing Data Processing Costs, particularly for processing a large dataset of text items or images; for example, the method comprising: Utilizing a Large Language Model (LLM) to automatically label a sample of data items from a larger dataset; Training a Machine Learning (ML) model on the labeled sample to create a predictive model; Applying the trained ML model to the larger dataset, thereby eliminating the need for extensive manual labeling and reducing overall processing costs.

In some embodiments, the methods may optionally include: pre-processing the unlabeled data items to remove noise or irrelevant information before applying the Large Language Model (LLM).

In some embodiments, the Machine Learning (ML) model is selected from a group consisting of support vector machines, decision trees, random forests, gradient boosting machines, and neural networks. In some embodiments, the training of the Machine Learning (ML) model employs a cross-validation technique to optimize model parameters. In some embodiments, the method may optionally include: post-processing the output of the trained Machine Learning (ML) model to adjust classifications based on predefined rules or threshold values.

In some embodiments, the LLM-labeled (or VLM-labeled) dataset is divided into a training set and a testing set, with the testing set used to evaluate the performance of the trained Machine Learning (ML) model.

In some embodiments, optionally, the Machine Learning (ML) model is updated periodically (e.g., once a week, once a month) with new data items to improve classification accuracy over time. Some embodiments may optionally employ an ensemble method, by combining multiple Machine Learning (ML) models to improve the overall classification performance. In some embodiments, the classification of new, unlabeled data items includes assigning a confidence score indicating the probability of the classification being correct.

In some embodiments, the unlabeled data items include textual content, and the classification involves categorizing the textual content into predefined categories.

In some embodiments, the unlabeled data items include visual content, and the classification involves identifying objects or themes within the visual content.

In some embodiments, the method includes using the classified data items to train a secondary ML model that is configured to perform a different classification task than the primary classification task. For example, a dataset of LLM-labeled text items, can be used for creating: a first dataset of LLM-labeled text items for training a first ML model for estimating the Urgency of each text item, and a second dataset of LLM-labeled text items for training a second ML model for estimating whether a text item contains

Sensitive Information. Similarly, a dataset of images may be analyzed by the VLM, to generate a first dataset of VLM-labeled images that is utilized for training a first Deep Neural Network model for detecting nudity, and to generate a second dataset of VLM-labeled images that is utilized for training a second Deep Neural Network model for detecting spam-related visual content.

In some embodiments, the application of the trained Machine Learning (ML) model to classify new, unlabeled data items is performed in real-time or near real-time.

In some embodiments, the method further comprises integrating the classified data items into a database, wherein the database supports advanced querying based on the classifications.

In some embodiments, the LLM or VLM utilizes a fine-tuning process on a subset of the unlabeled data items to improve the relevance and accuracy of the preliminary labels before training the Machine Learning (ML) model or the DNN or Deep CNN model.

In some embodiments that utilize the VLM for image processing, the VLM can be selected from the group consisting of OpenAI's GPT variants with vision capabilities, Google's Vision Transformer (ViT), and other models capable of processing and understanding image content.

In some embodiments, optionally, the images are pre-processed prior to labeling by the VLM to enhance features relevant to the classification task.

In some embodiments, optionally, the method includes: augmenting the dataset of non-labeled images with synthetically generated images to increase the diversity and volume of the training data.

In some embodiments, optionally, the Neural Network model includes one or more Convolutional Neural Networks (CNNs) or Deep Neural Networks (DNNs) or Deep CNNs, that are specifically designed for image recognition tasks.

In some embodiments, the training of the Neural Network model or the DNN model employs a transfer learning approach, using a pre-trained network as the starting point and fine-tuning it on the VLM-labeled dataset.

In some embodiments, the method optionally includes: validating the trained Neural Network model against a separate testing set of images not used during the training process.

In some embodiments, the classification tasks include identifying specific objects, scenes, or activities within the images.

In some embodiments, the method includes: deploying the trained Neural Network model in a cloud computing environment to facilitate scalability and accessibility.

In some embodiments, the labeled dataset is dynamically updated with new images over time, and the Neural Network model is periodically retrained to incorporate the new data.

In some embodiments, the Neural Network model is integrated into a larger system capable of performing actions based on the classification results, such as sorting images, alerting users, or flagging content for reviewing purposes or for quarantine purposes.

In some embodiments, the image classification results optionally include confidence scores reflecting the probability that the classification is correct.

In some embodiments, the method may optionally comprise: post-processing the classification results to apply custom rules or criteria set by the user.

In some embodiments, the VLM is configured to label the images based on a predefined schema tailored to specific industry needs, such as medical diagnosis, banking, manufacturing, or retail.

In some embodiments, the method optionally includes: applying image segmentation techniques before classification to isolate relevant features or objects within the images.

In some embodiments, the system provides feedback mechanisms for users to correct or verify classifications, which are then used to further refine and improve the Neural Network model through continuous learning.

Some embodiments may provide various advantages or benefits, such as: (a) Cost Efficiency: Significantly reduces the financial resources required for manual data labeling and analysis by leveraging automated machine learning models, making large-scale data processing economically feasible. (b) Time Savings: Accelerates the process of classifying large datasets by automating the labeling and training steps, freeing up valuable time for data scientists and analysts. (c) Scalability: Easily scales to accommodate growing data volumes without a corresponding increase in processing time or resources, supporting businesses as their data analysis needs expand. (d) Improved Accuracy: Enhances the accuracy of data classification by using advanced machine learning algorithms trained on large, diverse datasets, reducing the likelihood of human error (e) Real-time Processing: Enables the rapid classification of data in real-time or near real-time, providing immediate insights that can be crucial for time-sensitive applications. (f) Versatility: some embodiments are applicable to a wide range of data types, including text, images, and videos, making it a versatile tool for various industries and domains and sectors. (g) Enhanced Security: by automatically identifying urgent or sensitive content or problematic content or fraud-related content, some embodiments supports and assist cybersecurity mechanisms and help in the early detection of potential threats or breaches. (h) Continuous Improvement: The system can be continuously updated with new data, allowing the ML models to adapt and improve over time for even more precise classifications. (i) Resource Efficiency: Operates effectively on CPUs and standard computing hardware without the need for specialized equipment like high-end GPUs, further reducing operational costs. (j) User-driven Adaptability: Offers the ability to fine-tune models based on specific user feedback or requirements, enhancing the relevance and utility of the classification results for particular use cases.

Some embodiments may optionally provide the following surprising or counter-intuitive or non-intuitive benefits or features: (1) LLM Pre-labeling Efficiency; the use of Large Language Models (LLMs) for pre-labeling data is a novel approach that greatly reduces the time and cost associated with manual data labeling. (2) Cross-Domain ML Model Training; the ability to automatically train Machine Learning (ML) models across varied data types (text, images, videos) using a unified methodology is versatile. (3) Minimal Hardware Requirements: the system's operation on standard CPU hardware, avoiding the need for costly GPUs, is counter-intuitive to the common approach in AI processing and model training. (4) Real-time Classification; implementing ML models that classify data in real-time or near real-time without significant delay is an innovative feature that enhances decision-making processes. (5) LLM-driven Synthetic Data Generation; generating synthetic data for training when real data is insufficient, by using an LLM, is a creative solution that ensures model robustness. (6) Dynamic Model Updating; the capacity for ML models to dynamically update and improve with new incoming data challenges the static nature of traditional models, ensuring continuous learning and adaptation. (7) Cost-effective Scaling; the scaling efficiency, where processing large datasets does not proportionally increase costs, is a counter-intuitive benefit that contradicts common scaling challenges. (8) Automated Urgency Detection, in a demonstrative user case; automatically determining the urgency of communications, such as emails, using ML models, presents a surprising approach to enhancing cybersecurity measures. (9) Sensitive Content Identification, in a demonstrative user case; the ability to automatically detect sensitive or confidential information within documents using AI, reducing human oversight, and is a novel application of machine learning. (10) Multi-LLM Consensus for Labeling; employing multiple LLMs for initial data labeling and using a consensus approach (or other prevailing label approach) for accuracy is an innovative method for improving label reliability. (11) LLM Fine-tuning for Specific Labeling Tasks, to ensure that data is optimally prepared for ML model training. (12) Integration with Existing Systems; the system can seamlessly integrate with existing organizational infrastructure for immediate deployment and use. (13) Optionally, an Automated Sensitivity Level Adjustment; by automatically adjusting the sensitivity level of the ML models based on real-world performance metrics and feedback, to maintain relevance and accuracy. (14) Hybrid Model Deployment; by combining the strengths of both LLMs for data labeling and ML models for classification, optimizing both accuracy and efficiency.

In some embodiments, synthetic data/synthetic text/synthetic text-portions/synthetic text-segments/synthetic documents/synthetic messages, that were composed/generated/created by a machine (e.g., an LLM, based on a prompt) may be used as non-labeled textual data-items that are then labeled by the LLM, thus creating LLM-labeled textual data-items on which the ML model is trained. For example, a first LLM may be prompted, “please generate 400 different textual paragraphs, each of them presenting a request or asking a question while conveying a sense of urgency; and please also generate separately 400 more (and different) textual paragraphs, each of them presenting a request or asking a question without conveying a sense of urgency, or conveying that the request or question is non-urgent”. Those 800 synthetic textual paragraphs, that were generated by that First LLM, can then be used as synthetic textual data-items that a Second LLM (or even, the same First LLM, without a-priory contextual knowledge about which prompt generated which textual item) can then label, thus creating a corpus of 800 textual paragraphs that were synthetically LLM-created and then LLM-labeled. Similarly, the First LLM may be prompted to generate 300 textual paragraphs that convey a fraudulent intent or a malicious operation, and 300 other textual paragraphs that do not; and those synthetic 600 data-items can then be LLM-labeled (e.g., by another, separate, LLM that does not know which item was generated by which prompt), thus creating a corpus of 600 textual paragraphs that were synthetically LLM-created and then LLM-labeled. Of course, thousands or tens-of-thousands of textual items may be generated synthetically.

In some embodiments, the training dataset may comprise only synthetic textual data-items. In other embodiments, the training dataset may comprise only organic/human composed/non-synthetic textual data-items. In still other embodiments, the training dataset may include a mixture or a combination of the two types of textual data-items.

In some embodiments, synthetic images/synthetic video frames/synthetic graphical objects/synthetic visual data-items, that were composed/generated/created by a machine (e.g., a VLM based on a prompt, or an AI-based image generator or visual content generator) may be used as non-labeled visual/image data-items that are then labeled by the VLM (or LMM), thus creating VLM-labeled (or LMM-labeled) data-items on which the ML model is trained. For example, a first VLM may be prompted, “please generate 400 different images, each of them presenting a different content while conveying a sense of urgency; and please also generate separately 400 more (and different) images, each of them presenting a content without conveying a sense of urgency, or while conveying content that is non-urgent”. Those 800 synthetic images, that were generated by that First VLM, can then be used as synthetic images that a Second VLM (or even, the same First VLM, without a-priory contextual knowledge about which prompt generated which image) can then label, thus creating a corpus of 800 images paragraphs that were synthetically VLM-created and then VLM-labeled. Similarly, the First VLM may be prompted to generate 300 images that convey a fraudulent intent or a malicious operation, and 300 other images that do not; and those synthetic 600 images can then be VLM-labeled (e.g., by another, separate, VLM that does not know which image was generated by which prompt), thus creating a corpus of 600 images that were synthetically VLM-created and then VLM-labeled. Of course, thousands or tens-of-thousands of images may be generated synthetically.

In some embodiments, the training dataset may comprise only synthetic images (or synthetic visual data-items). In other embodiments, the training dataset may comprise only organic/human composed/non-synthetic images (or visual data-items). In still other embodiments, the training dataset may include a mixture or a combination of the two types of images (or visual data-items).

In some embodiments, optionally, a Feedback Loop may be added or utilized, to further improve the accuracy of the deployed system. Some options for implementing such Feedback Loop may include, for example: (1) User Correction Interface, where users can manually correct misclassifications; these corrections feed back into the model, allowing it to learn from its mistakes and refine its accuracy over time. (2) Automated Re-labeling Mechanism, as an automated process where the system periodically revisits and re-labels a subset of data points using updated models, then re-trains the main model with this refined data. (3) Performance Monitoring Dashboards, that track the performance metrics of the model in real-time, including accuracy, precision, and recall; and insights from these dashboards can guide targeted improvements and model adjustments. (4) Active Learning Loop, where the system identifies and flags data points for which it has low confidence in its classification, then prioritizes these for human review and retraining. (5) Client Feedback Integration, that collects and integrates feedback from end-users or clients regarding the relevance and accuracy of the classification results, and using this feedback to continuously update and fine-tune the model parameters. (6) Optionally, utilization of Model Versioning and A/B Testing, such as, employing model versioning and conducting A/B testing with different model versions to systematically evaluate improvements or changes, feeding the outcomes back to inform model development. (7) Anomaly Detection for Retraining, such as, implementing anomaly detection algorithms to identify outliers or anomalies in classified data automatically; and these findings can trigger a review and potential retraining cycle for the model to address gaps in its learning.

Some embodiments provide a comprehensive system for the automatic generation and refinement of Machine Learning (ML) models dedicated to classifying unlabeled data across diverse formats, including text, images, and videos. Central to its innovation is the utilization of Large Language Models (LLMs) for the initial labeling of data, which significantly economizes on the traditionally labor-intensive and costly process of manual data annotation. The system is engineered to support a wide array of applications, from assessing the urgency of incoming messages to detecting sensitive content within documents, showcasing its versatility. The system can operate efficiently on standard computing infrastructure, sidestepping the need for high-end GPUs and thus dramatically reducing setup costs and operational costs. The architecture is designed for scalability, allowing it to handle growing data volumes without proportional increases in expense or time. Furthermore, some embodiments may optionally incorporate mechanisms for continuous improvement, such as feedback loops that refine the model's accuracy over time based on user corrections and/or performance metrics. This ensures that the system not only starts strong but also improves its precision and reliability with use.

Some embodiments provide a computerized method comprising: (a) obtaining a dataset of non-labeled text-items; (b) defining a text classification task; (c) defining a prompt that commands a Large Language Model (LLM) to generate output that fulfills said text classification task; (d) automatically feeding into said LLM said prompt and text-items from the dataset of non-labeled text-items, and automatically generating by said LLM a dataset of LLM-labeled text-items; (e) automatically training a Machine Learning (ML) model on said dataset of LLM-labeled text-items, and generating a trained ML model; (f) deploying the trained ML model in an application that performs said text classification task on newly-received non-labeled text-items.

In some embodiments, the dataset of non-labeled text-items comprises only non-synthetic textual data-items; wherein the ML model is trained on a training dataset of non-synthetic text-items that were labeled by the LLM.

In some embodiments, the dataset of non-labeled text-items comprises only synthetic textual data-items; wherein the ML model is trained on a training dataset of synthetic text-items that were labeled by the LLM.

In some embodiments, the dataset of non-labeled text-items comprises both (i) non-synthetic textual data-items, and (ii) synthetic textual data-items; wherein the ML model is trained on a training dataset that includes both (I) non-synthetic textual data-items that were labeled by the LLM, and (ii) synthetic textual data-items that were labeled by the LLM.

In some embodiments, the method further comprises: fine-tuning the LLM to particularly specialize in performing said text classification task, to improve accuracy of the training dataset that the LLM generates for training the ML model.

In some embodiments, the LLM comprises a plurality of independent LLMs; wherein, for each of the non-labeled text-items: each LLM independently receives said prompt and independently generates a labeling output, and an LLMs Arbitration Unit selects one of a plurality of the labeling outputs based on a pre-defined arbitration scheme.

In some embodiments, the method comprises: automatically generating the trained ML model particularly for a text classification task of classifying incoming messages as fraudulent or legitimate.

In some embodiments, the method comprises: automatically generating the trained ML model particularly for a text classification task of classifying incoming messages as spam or non-spam.

In some embodiments, the method comprises: automatically generating the trained ML model particularly for a text classification task of classifying incoming messages as urgent or non-urgent.

In some embodiments, the method comprises: automatically generating the trained ML model particularly for a text classification task of classifying incoming messages as containing sensitive information or not containing sensitive information.

In some embodiments, a system comprises one or more hardware processors that are configured to execute code, and that are operably associated with one or more memory units that are configured to execute code; wherein the one or more hardware processors are configured to perform a computerized method as described above and/or below.

Some embodiments provide a computerized process comprising: (a) obtaining a dataset of non-labeled images; (b) defining an image classification task; (c) defining a prompt that commands a Vision and Language Model (VLM) to generate output that fulfills said image classification task; (d) automatically feeding into said VLM said prompt and images from the dataset of non-labeled images, and automatically generating by said VLM a dataset of VLM-labeled images; (e) automatically training a Deep Neural Network model (DNN) on said dataset of VLM-labeled images, and generating a trained Deep Neural Network model; (f) deploying the trained DNN model in an application that performs said image classification task on newly-received images.

In some embodiments, the dataset of non-labeled images comprises only non-synthetic images; wherein the Deep Neural Network model is trained on a training dataset of non-synthetic images that were labeled by the VLM.

In some embodiments, the dataset of non-labeled text-items comprises only synthetic images; wherein the Deep Neural Network model is trained on a training dataset of synthetic images that were labeled by the VLM.

In some embodiments, the dataset of non-labeled images comprises both (i) non-synthetic images, and (ii) synthetic images; wherein the Deep Neural Network model is trained on a training dataset that includes both (I) non-synthetic images that were labeled by the VLM, and (ii) synthetic images that were labeled by the VLM.

In some embodiments, the process comprises: fine-tuning the VLM to particularly specialize in performing said image classification task, to improve accuracy of the training dataset that the VLM generates for training the Deep Neural Network model.

In some embodiments, the VLM comprises a plurality of independent VLMs; wherein, for each of the non-labeled images: each VLM independently receives said prompt and independently generates a labeling output, and an VLMs Arbitration Unit selects one of a plurality of the labeling outputs based on a pre-defined arbitration scheme.

In some embodiments, the process comprises: automatically generating the trained Deep Neural Network model particularly for an image classification task of classifying images as containing nudity or not containing nudity.

In some embodiments, the process comprises: automatically generating the trained Deep Neural Network model particularly for an image classification task of classifying images as being fraud-related or not being fraud-related.

Some embodiments provide a non-transitory storage medium having stored thereon instructions that, when executed by a machine, cause the machine to perform a method as described above and/or herein.

Some embodiments provide a system comprising: one or more hardware processors, configured to execute code; associated with one or more memory units, configured to store data; wherein the one or more hardware processors are configured to perform an automated process or an automated method as described above and/or herein.

Although portions of the discussion herein relate, for demonstrative purposes, to wired links and/or wired communications, some embodiments of the present invention are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be implemented by using hardware units, software units, processors, CPUs, DSPs, GPUs, integrated circuits (ICs), logic gates, logic units, memory units, storage units, wireless communication modems or transmitters or receivers or transceivers, cellular transceivers, a power source, input units, output units, Operating System (OS), drivers, applications, and/or other suitable components.

Some embodiments may be implemented by using a special-purpose machine or a specific-purpose that is not a generic computer, or by using a non-generic computer or a non-general computer or machine. Such system or device may utilize or may comprise one or more units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented by using code or program code or machine-readable instructions or machine-readable code, which is stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such device to perform a method in accordance with the present invention.

Some embodiments may be utilized with a variety of devices or systems having a touch-screen or a touch-sensitive surface; for example, a smartphone, a cellular phone, a mobile phone, a smart-watch, a tablet, a handheld device, a portable electronic device, a portable gaming device, a portable audio/video player, a Virtual Reality (VR) or Augmented Reality (AR) or Mixed Reality (MR) device or headset or gear, a “kiosk” type device or a vending machine or an Automatic Teller Machine (ATM), a laptop computer, a desktop computer, a vehicular computer or system, a vehicular dashboard, a vehicular touch-screen, or the like.

The system(s) and/or device(s) of some embodiments may optionally comprise, or may be implemented by utilizing suitable hardware components and/or software components; for example, processors, processor cores, Central Processing Units (CPUs), Digital Signal Processors (DSPs), circuits, Integrated Circuits (ICs), controllers, memory units, registers, accumulators, storage units, input units (e.g., touch-screen, keyboard, keypad, stylus, mouse, touchpad, joystick, trackball, microphones), output units (e.g., screen, touch-screen, monitor, display unit, audio speakers), acoustic microphone(s) and/or sensor(s), optical microphone(s) and/or sensor(s), laser or laser-based microphone(s) and/or sensor(s), wired or wireless modems or transceivers or transmitters or receivers, GPS receiver or GPS element or other location-based or location-determining unit or system, network elements (e.g., routers, switches, hubs, antennas), and/or other suitable components and/or modules.

The system(s) and/or devices of some embodiments may optionally be implemented by utilizing co-located components, remote components or modules, “cloud computing” servers or devices or storage, client/server architecture, peer-to-peer architecture, distributed architecture, and/or other suitable architectures or system topologies or network topologies.

In accordance with some embodiments, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit, a Flash drive), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL), BASIC, Visual BASIC, MATLAB, Pascal, HTML, HTML5, CSS, Dart, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

Some embodiments of the present invention may perform steps or operations such as, for example, “determining”, “identifying”, “comparing”, “checking”, “querying”, “searching”, “matching”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range values and/or upper limit value and/or lower limit value and/or maximum value and/or minimum value; a comparison or matching between sensed or measured or calculated data, and one or more values as stored in a look-up table or a legend table or a list of reference value(s) or a database of reference values or ranges; a comparison or matching or searching process which searches for matches and/or identical results and/or similar results and/or sufficiently-close results (e.g., within a pre-defined threshold level of similarity; such as, within 5 percent above or below a pre-defined threshold value), among multiple values or limits that are stored in a database or look-up table; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Repeated use of the phrase “in one embodiment” does not necessarily refer to the same embodiment, although it may. Repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may comprise, or may be implemented by using, an “app” or application which may be downloaded or obtained from an “app store” or “applications store”, for free or for a fee, or which may be pre-installed on a computing device or electronic device, or which may be transported to and/or installed on such computing device or electronic device.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may comprise any possible combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some embodiments have been illustrated and described herein, many modifications, substitutions, changes, and equivalents may occur to those skilled in the art. Accordingly, the claims are intended to cover all such modifications, substitutions, changes, and equivalents.

What is claimed is:

1. A computerized method comprising:
(a) obtaining a dataset of non-labeled text-items;
(b) defining a text classification task;
(c) defining a prompt that commands a Large Language Model (LLM) to generate output that fulfills said text classification task;
(d) automatically feeding into said LLM said prompt and text-items from the dataset of non-labeled text-items, and automatically generating by said LLM a dataset of LLM-labeled text-items;
(e) automatically training a Machine Learning (ML) model on said dataset of LLM-labeled text-items, and generating a trained ML model;
(f) deploying the trained ML model in an application that performs said text classification task on newly-received non-labeled text-items.

2. The computerized method of claim 1,
wherein the dataset of non-labeled text-items comprises only non-synthetic textual data-items;
wherein the ML model is trained on a training dataset of non-synthetic text-items that were labeled by the LLM.

3. The computerized method of claim 1,
wherein the dataset of non-labeled text-items comprises only synthetic textual data-items;
wherein the ML model is trained on a training dataset of synthetic text-items that were labeled by the LLM.

4. The computerized method of claim 1,
wherein the dataset of non-labeled text-items comprises both (i) non-synthetic textual data-items, and (ii) synthetic textual data-items;
wherein the ML model is trained on a training dataset that includes both (I) non-synthetic textual data-items that were labeled by the LLM, and (ii) synthetic textual data-items that were labeled by the LLM.

5. The computerized method of claim 1, further comprising:
fine-tuning the LLM to particularly specialize in performing said text classification task, to improve accuracy of the training dataset that the LLM generates for training the ML model.

6. The computerized method of claim 1,
wherein the LLM comprises a plurality of independent LLMs;
wherein, for each of the non-labeled text-items:
each LLM independently receives said prompt and independently generates a labeling output,
and an LLMs Arbitration Unit selects one of a plurality of the labeling outputs based on a pre-defined arbitration scheme.

7. The computerized method of claim 1, comprising:
automatically generating the trained ML model particularly for a text classification task of classifying incoming messages as fraudulent or legitimate.

8. The computerized method of claim 1, comprising:
automatically generating the trained ML model particularly for a text classification task of classifying incoming messages as spam or non-spam.

9. The computerized method of claim 1, comprising:
automatically generating the trained ML model particularly for a text classification task of classifying incoming messages as urgent or non-urgent.

10. The computerized method of claim 1, comprising:
automatically generating the trained ML model particularly for a text classification task of classifying incoming messages as containing sensitive information or not containing sensitive information.

11. A system comprising:
one or more hardware processors that are configured to execute code,
and that are operably associated with one or more memory units that are configured to execute code;
wherein the one or more hardware processors are configured to perform a computerized method comprising:
(a) obtaining a dataset of non-labeled text-items;
(b) defining a text classification task;
(c) defining a prompt that commands a Large Language Model (LLM) to generate output that fulfills said text classification task;
(d) automatically feeding into said LLM said prompt and text-items from the dataset of non-labeled text-items, and automatically generating by said LLM a dataset of LLM-labeled text-items;
(e) automatically training a Machine Learning (ML) model on said dataset of LLM-labeled text-items, and generating a trained ML model;
(f) deploying the trained ML model in an application that performs said text classification task on newly-received non-labeled text-items.

12. A computerized process comprising:
(a) obtaining a dataset of non-labeled images;
(b) defining an image classification task;
(c) defining a prompt that commands a Vision and Language Model (VLM) to generate output that fulfills said image classification task;
(d) automatically feeding into said VLM said prompt and images from the dataset of non-labeled images, and automatically generating by said VLM a dataset of VLM-labeled images;
(e) automatically training a Deep Neural Network model (DNN) on said dataset of VLM-labeled images, and generating a trained Deep Neural Network model;
(f) deploying the trained DNN model in an application that performs said image classification task on newly-received images.

13. The computerized process of claim 12,
wherein the dataset of non-labeled images comprises only non-synthetic images;
wherein the Deep Neural Network model is trained on a training dataset of non-synthetic images that were labeled by the VLM.

14. The computerized process of claim 12,
wherein the dataset of non-labeled text-items comprises only synthetic images;
wherein the Deep Neural Network model is trained on a training dataset of synthetic images that were labeled by the VLM.

15. The computerized process of claim 12,
wherein the dataset of non-labeled images comprises both (i) non-synthetic images, and (ii) synthetic images;
wherein the Deep Neural Network model is trained on a training dataset that includes both (I) non-synthetic images that were labeled by the VLM, and (ii) synthetic images that were labeled by the VLM.

16. The computerized process of claim 12,
further comprising:
fine-tuning the VLM to particularly specialize in performing said image classification task, to improve accuracy of the training dataset that the VLM generates for training the Deep Neural Network model.

17. The computerized process of claim 12,
wherein the VLM comprises a plurality of independent VLMs;
wherein, for each of the non-labeled images:
each VLM independently receives said prompt and independently generates a labeling output,
and an VLMs Arbitration Unit selects one of a plurality of the labeling outputs based on a pre-defined arbitration scheme.

18. The computerized process of claim 12, comprising:
automatically generating the trained Deep Neural Network model particularly for an image classification task of classifying images as containing nudity or not containing nudity.

19. The computerized process of claim 12, comprising:
automatically generating the trained Deep Neural Network model particularly for an image classification task of classifying images as being fraud-related or not being fraud-related.

20. A computerized system comprising:
one or more hardware processors that are configured to execute code,
and that are operably associated with one or more memory units that are configured to execute code;
wherein the one or more hardware processors are configured to perform a computerized process comprising:
(a) obtaining a dataset of non-labeled images;
(b) defining an image classification task;
(c) defining a prompt that commands a Vision and Language Model (VLM) to generate output that fulfills said image classification task;
(d) automatically feeding into said VLM said prompt and images from the dataset of non-labeled images, and automatically generating by said VLM a dataset of VLM-labeled images;
(e) automatically training a Deep Neural Network model (DNN) on said dataset of VLM-labeled images, and generating a trained Deep Neural Network model;
(f) deploying the trained DNN model in an application that performs said image classification task on newly-received images.
